(19) United States
(12) Patent Application Publication
(10) Pub. No.: US 2011/0299222 A1
(43) Pub. Date: Dec. 8, 2011

(54) METHOD FOR MANUFACTURING RESIN FILM FOR THIN FILM-CAPACITOR AND THE FILM THEREFOR

(75) Inventors: Kazuhiro SUZUKI, Saitama-shi (JP); Takashi Gonda, Saitama-shi (JP); Norimasa Shinada, Saitama-shi (JP); Yuzo Morioka, Saitama-shi (JP)

(73) Assignee: SHIN-ETSU POLYMER CO., LTD., Tokyo (JP)

(21) Appl. No.: 12/980,962

(22) Filed: Dec. 29, 2010

(30) Foreign Application Priority Data
Jun. 7, 2010 (JP) 2010-129886

(51) Int. Cl. H01G 4/08; B29C 47/88; H01G 4/00

(52) U.S. Cl. 361/323; 264/211.12

(57) ABSTRACT

The present invention provides a method for manufacturing a film for a film capacitor in which a film can be prepared by melt extrusion molding in a thin film having a thickness of 10 μm or less and in which a cost can be cut by simplifying a manufacturing step thereof and a film for a film capacitor. It is a method for manufacturing a film for a film capacitor comprising the steps of charging a melt extrusion molding equipment 10 with a molding material 1 to mold a film 20 for a film capacitor by extruding from a dice 12, interposing the above extruded and molded film 20 for a film capacitor between a pressing roll 31 and a metal roll 32 to cool it and winding up the cooled film 20 for a film capacitor having a thickness of 10 μm or less in order on a winding tube 41 of a winding device 40, wherein the molding material 1 is prepared by adding a fluorocarbon resin to a PEI resin having a glass transition point of 200° C. or higher and a dielectric breakdown voltage of 100 V/μm or more; and a uniaxial elongational viscosity of the above molding material 1 is controlled to a range of 6,000 to 20,000 Pa·s.

This Nonprovisional application claims priority under 35 U.S.C. §119(a) on Patent Application No. 2010-129886 filed in Japan on 7 Jun. 2010, the entire contents of which are hereby incorporated by reference.

### BACKGROUND OF THE INVENTION AND RELATED ART STATEMENT

(1) Field of the Invention

The present invention relates to a method for manufacturing a film for a film capacitor which can enhance a voltage resistant characteristic and the like and a film for a film capacitor.

(2) Description of the Prior Art

A capacitor can be classified into three kinds of a thin film capacitor (or a plastic capacitor), a ceramic capacitor and an aluminum electrolysis capacitor according to the kind of dielectric substances. Among three kinds of the above capacitors, the film capacitor has characteristics such as less characteristic change to temperature and a frequency, a high insulation property, a small dielectric loss and the like, and therefore it is considered to be more excellent than other capacitors (refer to a non-patent document 1).

In the above resin film for a film capacitor, polypropylene (PP), polystyrene (PS), polyethylene terephthalate (PET), polycarbonate (PC), polyvinylidene fluoride, polyethylene tetrafluoride, polyimide, polyphenylene sulfide (PPS), polyethylene naphthalate (PEN) and the like have been used and molded into a thin film of 10 μm or less, and polypropylene, polyethylene terephthalate, polyphenylene sulfide and polyethylene naphthalate are used in many cases at present from the viewpoints of a cost and a processability (refer to a non-patent document 1).

However, because of the reasons that a use temperature of polypropylene is 105° C. or lower and that a use temperature of polyethylene terephthalate is 125° C., films for a film capacitor made of polypropylene and polyethylene terephthalate have the defect that they are inferior in a heat resistance when they are used to a film for a film capacitor in hybrid cars to which a heat resistance of 150° C. or higher is required (refer to a non-patent document 2).

On the other hand, a film for a film capacitor made of polyphenylene sulfide has a use temperature of 160° C. or lower and is excellent in a heat resistance, but it has a low dielectric breakdown voltage and is inferior in a voltage resistant characteristic, so that a use range thereof is likely to be limited. Further, a film for a film capacitor made of polyethylene terephthalate has a use temperature of 160° C. or lower and is excellent as well in a heat resistance, but it has a large dielectric loss and a large temperature dependability of a dielectric dissipation factor, so that a use range thereof is limited as well (refer to the non-patent document 1 and the non-patent document 2).

In light of the above limitations, a film for a film capacitor made of a polyetherimide resin (hereinafter referred to as a PEI resin) attracts attentions as a material of a film capacitor in recent years. The above film for a film capacitor made of the PEI resin has a glass transition point of 200° C. or higher, an excellent heat resistance and a high dielectric breakdown voltage, and in addition thereto, it is excellent as well in a voltage resistant characteristic and has a small frequency dependability and a small temperature dependability of a dielectric loss tangent, so that it is most suitable for a film capacitor (refer to a patent document 1).

### CROSS-REFERENCE TO RELATED APPLICATIONS

Non-patent document 1: “Technical Trend of Film for Condenser” Convertec, No. 40, July issue, p. 82 to 88, 2006
Non-patent document 2: “Condenser Technique Feature” Radio Wave News Paper 22th page, 23th page, Jan. 24, 2008
Patent document 1: Japanese Patent Application Laid-Open No. 274023/2008

### SUMMARY OF THE INVENTION

A film for a film capacitor made of a PEI resin can be molded in a thin film having a thickness of 10 μm or less by a melt extrusion molding method, and high speed molding is required for the above molding. However, when a PEI resin is molded at a high speed by the melt extrusion molding method, draw resonance is brought about during molding, and the film for a film capacitor is broken in a certain case due to a periodic change in a thickness. Accordingly, it is very difficult to subject the film for a film capacitor made of the PEI resin to melt extrusion molding in a thin film having a thickness of 10 μm or less.

The molding method described in the patent document 1 is a solvent casting method, and it is an effective method for molding a film to which a thickness accuracy is required. However, a molding step thereof is very troublesome and complicated, and the film has to be dried over a long period of time in order to remove completely the solvent. Accordingly, the problem that the film obtained is very expensive to make it impossible to cut the cost is involved therein.

The present invention has been made in light of the problems described above, and an object thereof is to provide a method for manufacturing a film for a film capacitor in which a film can be subjected to melt extrusion molding in a thin film having a thickness of 10 μm or less and in which a cost can be cut by simplifying a manufacturing step thereof and a film for a film capacitor.

Intense researches repeated by the present inventors in order to solve the problems described above have resulted in paying attentions to a uniaxial elongational viscosity of a molding material and finding that draw resonance brought about during melt extrusion molding can be prevented by controlling the above uniaxial elongational viscosity of the molding material, and thus the present invention has been completed.

That is, in order to solve the problems described above, the present invention is characterized by a method for manufacturing a film for a film capacitor comprising the steps of feeding a molding material into an extruding equipment, extruding a film for a film capacitor downward from a dice thereof, interposing the above extruded film for a film capacitor between a pressing roll and a cooling roll to cool it and winding up the cooled film for a film capacitor having a thickness of 10 μm or less on a winding device, wherein the molding material is prepared by adding a fluorocarbon resin to a polyetherimide resin having a glass transition point of 200° C. or higher and a dielectric breakdown voltage of 100 V/μm or more; and a uniaxial elongational viscosity of the molding material is controlled to a range of 6,000 to 20,000 Pa·s.

The molding material prepared by mixing the fluorocarbon resin with the polyetherimide resin while stirring to prepare a stirred mixture and melting and kneading the above stirred mixture is dried, and it can be charged into the melt extrusion molding equipment.

A tetrafluoroethylene-hexafluoropropyl copolymer and a tetrafluoroethylene-perfluoroalkyl vinyl ether copolymer are selected as the fluorocarbon resin, and a strain curing area of the molding material can be controlled in a range of an elongation rate of 10 s⁻¹ to 50 s⁻¹ in an elongational viscosity curve at a temperature of 340° C.

Further, fine irregularities are formed on the film for a film capacitor to control a form thereof to 0.5 μm in terms of a roughness in a center line average height, and a frictional coefficient of the film for a film capacitor can be reduced.

Also, a slit knife edge for forming a slit on the film for a film capacitor is arranged between the pressing roll and a winding tube of the winding equipment, and tension rolls of a number required for exerting a tension on the film for a film capacitor can rotatably be disposed between the winding equipment and the slit knife edge.

Further, in order to solve the problems described above, the present invention is characterized by manufacturing the film for a film capacitor by the method for manufacturing a film for a film capacitor.

In this regard, the molding material in the scope of claim 1 is preferably dried after adding the fluorocarbon resin to the polyetherimide resin. The polyetherimide resin and the fluorocarbon are preferably molten and kneaded after mixed at room temperature by stirring. Usually, the fluorocarbon resin is preferably solid at a temperature of lower than a melting point thereof. A uniaxial elongational viscosity of the molding material can be measured by means of a commercial uniaxial elongational viscometer. Further, at least various kinds of extrusion molding equipments are included in the melt extrusion molding equipment.

According to the present invention, the film for a film capacitor can be subjected to melt extrusion molding in a thin film having a thickness of 10 μm or less, and the effect that the cost can be cut by simplifying a manufacturing step thereof to enhance the economical efficiency is provided.

### BRIEF DESCRIPTION OF THE DRAWINGS

FIG. 1 is an explanatory drawing schematically showing the embodiment of the method for manufacturing a film for a film capacitor according to the present invention.

### DESCRIPTION OF THE PREFERRED EMBODIMENT

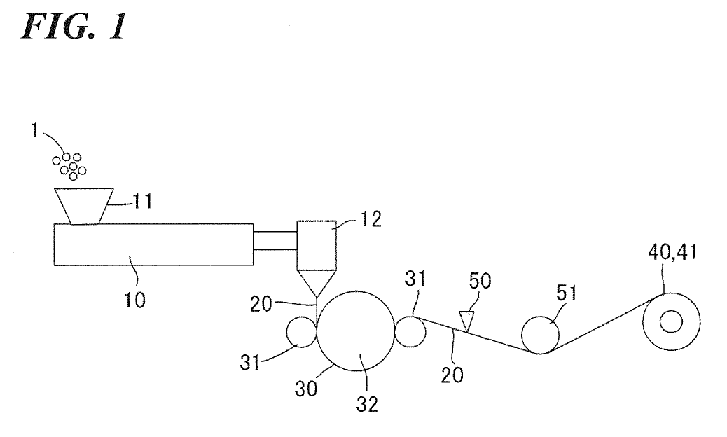

The embodiment of the present invention shall be explained below with reference to the drawing. The method for manufacturing a film for a film capacitor in the embodiment of the present invention is a manufacturing method in which, as shown in FIG. 1, a melt extrusion molding equipment 10 is charged with a molding material 1, and a film 20 for a film capacitor is extruded immediately downward from a tip of a dice 12 thereof and molded; the above extruded and molded film 20 for a film capacitor is interposed in a receiving device 30 and cooled while withdrawn rapidly and instantly; and the above cooled thin film 20 for a film capacitor having a thickness of 10 μm or less is wound continuously on a winding device 40.

The molding material 1 is prepared by adding 1.0 to 30 parts by mass of a fluorocarbon resin having a melt viscosity of 120,000 poise or less, preferably 5,000 to 110,000 poise to 100 parts by mass of a polyetherimide resin having a glass transition point of 200° C. or higher and a dielectric breakdown voltage of 100 V/μm or more and kneading them, and a uniaxial elongational viscosity thereof obtained when measured by means of a uniaxial elongational viscometer is controlled to a range of 6,000 to 20,000 Pa·s, particularly preferably 6,500 to 18,000 Pa·s.

A polyimide resin (PI resin), a polyamideimide resin (PAI resin), a polyetherether ketone resin (PEEK resin), a polyether ketone resin (PK resin), a polysulfone resin (PSU resin), a polyether sulfone resin (PES resin), a polyphenylene sulfone resin (PPSU resin), a polyphenylene sulfide resin, a polyphenylene sulfide sulfone resin, a polyphenylene sulfide ketone resin, a liquid crystal polymer (LCP) and the like are added to the molding material 1 as long as the characteristics of the present invention are not damaged. The liquid crystal polymer may be any of a I type, a II type and a III type.

An antioxidant, a light stabilizer, a UV absorber, a plasticizer, a lubricant, a flame retardant, an antistatic agent, a heat resistance improver, an inorganic filler, an organic filler and the like in addition to the resins described above are added selectively to the molding material 1 as long as the characteristics of the present invention are not damaged.

The PEI resin of the molding material 1 shall not specifically be restricted and is a resin having a repetitive unit represented by the following chemical formula 1 or 2:

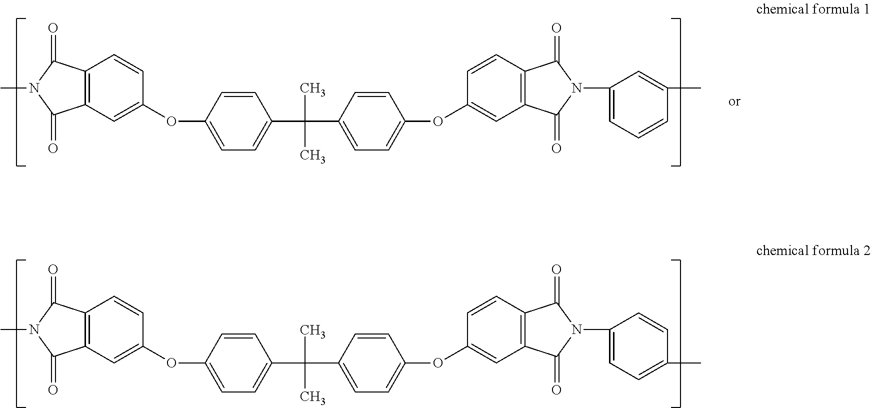

The specific examples of the above PEI resin include Ultem 1000-1000 having a glass transition point of 211° C. (trade name, manufactured by SABIC Innovative Plastics Japan Ltd.), Ultem 1010-1000 having a glass transition point of 223° C. (trade name, manufactured by SABIC Innovative Plastics Japan Ltd.), Ultem CRS5001-1000 having a glass transition point of 235° C. (trade name, manufactured by SABIC Innovative Plastics Japan Ltd.) and the like.

Manufacturing methods described in, for example, Japanese Patent Publication No. 9372/1982 and Japanese Patent Application Laid-Open No. 274023/2008 are used as a method for manufacturing the PEI resin. Block copolymers and random copolymers with other copolymerizable monomers and modified matters thereof can be used for the above PEI resin as long as the effects of the present invention are not damaged. For example, Ultem XH6050-1000 having a glass transition point of 252° C. (trade name, manufactured by SABIC Innovative Plastics Japan Ltd.) which is a polyetherimide sulfone copolymer can be used.

The fluorocarbon resin of the molding material 1 is a compound having a fluorine atom on a principal chain of a molecular structure in which a melt viscosity measured on the conditions of a temperature of 360° C. and a load of 50 kgf by means of a flow tester using a dice having a diameter of 1.0 mm and a length of 10 mm is 120,000 poise or less, and it functions so that a uniaxial elongational viscosity of the molding material 1 is improved.

A melt viscosity of the fluorocarbon resin is 120,000 poise or less because of the reasons that if it exceeds 120,000 poise, a fluidity of the fluorocarbon resin is notably reduced, so that fine projections are generated on a surface of the film 20 for a film capacitor and that the film 20 for a film capacitor is reduced in a dielectric breakdown voltage to bring about a problem on a voltage resistant characteristic thereof. Further, because of a high melt viscosity and a very small fluidity of the fluorocarbon resin, it is gelated to produce holes on the film 20 for a film capacitor in the gelated parts, or the film 20 for a film capacitor is reduced in a mechanical property due to inferior dispersion of the fluorocarbon resin to make the film 20 for a film capacitor liable to be broken in production thereof, and therefore it becomes difficult to produce the thin film.

Usually, the fluorocarbon resin is preferably solid at a temperature of lower than a melting point. This is because if the fluorocarbon resin is liquid, the fluorocarbon resin bleeds from the film 20 for a film capacitor after molding to contaminate an inside of the film capacitor.

The specific fluorocarbon resin corresponds to polytetrafluoroethylene (ethylene tetrafluoride resin, melting point: 325 to 330° C., continuous use temperature: 260° C., hereafter referred to as a PTFE resin), tetrafluoroethylene-perfluoroalkyl vinyl ether copolymers (ethylene tetrafluoride-perfluoroalkoxyethylene copolymer resin, melting point: 300 to 315° C., continuous use temperature: 260° C., hereafter referred to as a PFA resin), tetrafluoroethylene-hexafluoropropyl copolymers (ethylene tetrafluoride-propyl hexafluoride copolymer resin, melting point: 270° C., continuous use temperature: 200° C., hereafter referred to as an FEP resin), tetrafluoroethylene-ethylene copolymers (ethylene tetrafluoride-ethylene copolymer resin, melting point: 260 to 270° C., continuous use temperature: 150° C., hereafter referred to as an ETFE resin), polyvinylidene fluoride (vinylidene fluoride resin, melting point: 173 to 175° C., continuous use temperature: 150° C., hereafter referred to as a PVDF resin), polychlorotrifluoroethylene (ethylene trifluorochloride resin, melting point: 210 to 212° C., continuous use temperature: 120° C., hereafter referred to as a PCTFE resin), thermoplastic fluorocarbon resins comprising three kinds of monomers of tetrafluoroethylene, hexafluoropropylene and vinylidene fluoride (melting point: 120 to 250° C., continuous maximum use temperature: 80 to 210° C.) and the like.

Among the above fluorocarbon resins, the PFA resins and the FEP resins are most suitable from the viewpoints of an excellent heat resistance in which a continuous use temperature is 200° C. or higher, an availability, a handling property and costs. The above PFA resins and FEP resins can be used alone or in a blend.

An addition amount of the fluorocarbon resin is preferably 1.0 to 30 parts by mass, more preferably 3.0 to 20 parts by mass and further preferably 3.0 to 15 parts by mass based on 100 parts by mass of the PEI resin. This is because of the following reasons; if an addition amount of the fluorocarbon resin is less than 1.0 part by mass, a uniaxial elongational viscosity of the molding material 1 is less than 6,000 Pa·s, and draw resonance is generated during melt extrusion molding, so that it becomes very difficult to stably mold the film 20 for a film capacitor of a thin film having a thickness of 10 μm or less; on the other hand, if the addition amount exceeds 30 parts by mass, a uniaxial elongational viscosity of the molding material 1 exceeds 20,000 Pa·s, and therefore the film 20 for a film capacitor is reduced in melt elongation to make it impossible to mold the film 20 for a film capacitor of a thin film.

A uniaxial elongational viscosity of the molding material 1 falls in a range of preferably 6,000 Pa·s or more and 20,000 Pa·s or less, more preferably 8,000 Pa·s or more and 15,000 Pa·s or less at a temperature of 340° C. and an elongation rate falling in a range of 10 s⁻¹ or more and 50 s⁻¹ or less. This is because of the following reasons; if a uniaxial elongational viscosity of the molding material 1 is 6,000 Pa·s or less, draw resonance is generated during melt extrusion molding, so that it becomes very difficult to stably mold the film 20 for a film capacitor of a thin film having a thickness of 10 μm or less; on the other hand, if the uniaxial elongational viscosity exceeds 20,000 Pa·s, melt elongation is small, and therefore the film 20 for a film capacitor can not be molded in a thin film.

In the case described above, when manufacturing the film 20 for a film capacitor, the PEI resin and the fluorocarbon resin are mixed, as shown in FIG. 1, at room temperature by stirring and then molten and kneaded for prescribed time to prepare the molding material 1, and the molding material 1 is continuously extruded in a thin film to mold the film 20 for a film capacitor of a band form.

A method for preparing the molding material 1 includes (1) a method in which the PEI resin and the fluorocarbon resin are mixed by stirring at room temperature and then molten and kneaded to prepare the molding material 1 for the film 20 for a film capacitor and (2) a method in which the fluorocarbon resin is added to the molten PEI resin without mixing the PEI resin and the fluorocarbon resin by stirring and in which they are molten and kneaded to prepare the molding material 1. Either of the above methods can be employed, and the method (1) is preferred from the viewpoint of a dispersibility and a workability.

First, the method (1) shall be explained. When the PEI resin and the fluorocarbon resin are mixed by stirring, a tumbler mixer, a Henschel mixer, a V type mixing equipment, a Nauta mixer, a ribbon blender, a universal stirring mixer and the like are used.

The stirred and mixed matter of the PEI resin and the fluorocarbon resin obtained by the methods described above is molten, kneaded and dispersed by means of a mixing roll, a pressure kneader, a multishaft extrusion molding equipment such as a double shaft extrusion molding equipment, a three shaft extrusion molding equipment, a four shaft extrusion molding equipment and the like, whereby the molding material 1 can be prepared. When preparing the molding material 1 of the PEI resin and the fluorocarbon resin, a temperature of the melt kneading equipment is 260 to 400° C., preferably 300 to 400° C. This is because of the reason that when a temperature of the melt extrusion molding equipment 10 exceeds 400° C., the fluorocarbon resin is heavily decomposed, so that it is not preferred.

Next, the method (2) shall be explained. In a case of this method, the PEI resin is molten by means of a mixing roll, a pressure kneader, a Banbury mixer, a multishaft extrusion molding equipment such as a double shaft extrusion molding equipment, a three shaft extrusion molding equipment, a four shaft extrusion molding equipment and the like, and the fluorocarbon resin is added to the PEI resin to melt, knead and disperse them, whereby the molding material 1 of the PEI resin and the fluorocarbon resin is prepared. When preparing a composition comprising the PEI resin and the fluorocarbon resin, a temperature of the melt kneading equipment is 260 to 400° C., preferably 300 to 400° C. This is because of the reason that when the temperature exceeds 400° C., the fluorocarbon resin is heavily decomposed similarly to the case described above.

Usually, the molding material 1 is extruded in a bulk form, a strand form, a sheet form or a bar form and then used after turned into a form suited to mold processing, such as a powder form, a granular form, a pellet form and the like by means of a crushing equipment or a cutting equipment. The film 20 for a film capacitor comprising the molding material 1 can be manufactured by a publicly known method such as a melt extrusion molding method, a calendar molding method, a casting molding method and the like.

In this regard, the melt extrusion molding method is a method in which the molding material 1 comprising the PEI resin and the fluorocarbon resin is molten and kneaded by means of the melt extrusion molding equipment 10 comprising a single shaft extrusion molding equipment, a double shaft extrusion molding equipment and the like and in which it is continuously extruded from the dice 12 comprising a T dice, a round dice or the like connected to a tip part of the melt extrusion molding equipment 10 via a connecting tube to manufacture the film 20 for a film capacitor of a band form. The melt extrusion molding method is most suited to the method for manufacturing the film 20 for a film capacitor from the viewpoint of the handling property and simplification of the facilities.

A temperature of the melt extrusion molding equipment 10 and the dice 12 is 260 to 400° C., preferably 300 to 400° C. from the viewpoint of preventing the fluorocarbon resin from being heavily decomposed. A moisture content of the molding material 1 in manufacturing the film 20 for a film capacitor is controlled to 5000 ppm or less, preferably 2000 ppm or less before melt extrusion molding. This is because when the moisture content exceeds 5000 ppm, foaming of the film 20 for a film capacitor is likely to be brought about.

When the molding material 1 is put in a raw material supplying inlet 11 disposed at an upper backside of the melt extrusion molding equipment 10, an inert gas such as a helium gas, a neon gas, an argon gas, a krypton gas, a nitrogen gas, a carbon dioxide gas and the like may suitably be supplied to prevent oxidative degradation or oxidative cross-linking.

The film 20 for a film capacitor is subjected to melt extrusion molding, and then this film 20 for a film capacitor is delivered in order to a pair of pressing rolls 31 in a receiving equipment 30, a metal roll 32 which is a cooling roll and a winding tube 41 in a winding equipment 40 positioned in a downstream thereof to wind the film 20 for a film capacitor in order on the winding tube 41, whereby the film 20 for a film capacitor can be manufactured (refer to FIG. 1).

A slit knife edge 50 for forming a slit on a side part of the film 20 for a film capacitor by sliding is arranged, as shown in FIG. 1, at least up-and-down movably between the pressing roll 31 in the receiving equipment 30 and the winding tube 41 in the winding equipment 40, and a tension roll 51 for exerting a tension on the film 20 for a film capacitor to wind it smoothly is disposed rotatably between the winding tube 41 and the slit knife edge 50.

A rubber layer of at least natural rubber, isoprene rubber, butadiene rubber, norbornene rubber, acrylonitrile butadiene rubber, nitrile rubber, urethane rubber, silicone rubber, fluorocarbon rubber or the like is covered and formed on a contact surface of the press roll 31 from the viewpoint of enhancing close contact of the film 20 for a film capacitor with the metal roll 32, and among the above rubbers, the silicone rubber and the fluorocarbon rubber which are excellent in a heat resistance are preferably selected. An inorganic compound such as silica, alumina and the like may selectively be added to the rubber layer.

A metal elastic roll having a surface which is formed from metal can be used as well for the pressing roll 31, and when the above metal elastic roll is used, it becomes possible to form the film 20 for a film capacitor having a surface which is excellent in a flatness. Air Roll (trade name, manufactured by Dymco, Ltd.) and UF Roll (trade name, manufactured by Hitachi Zosen Corporation) correspond to the specific examples of the metal elastic roll.

Fine irregularities can be formed on a surface of the film 20 for a film capacitor to reduce a frictional coefficient on a surface of the film 20 for a film capacitor as long as the effects of the present invention are not lost. A method for forming the above fine irregularities includes (1) a method in which a composition of the PEI resin and the fluorocarbon resin is molten and kneaded by means of the melt extrusion molding equipment 10 and in which the above molten and kneaded composition is discharged from the dice 12 on the metal roll 32 having fine irregularities and brought into close contact with it to form the fine irregularities thereon at the same time as molding the film 20 for a film capacitor and (2) a method in which the film 20 for a film capacitor is once manufactured and then brought into close contact with a roll having fine irregularities to form the fine irregularities thereon. The method (1) is preferred from the viewpoint of simplifying the facilities.

An optimum form of the fine irregularities on a surface of the film 20 for a film capacitor is 0.50 μm or less, preferably 0.40 μm or less and more preferably 0.35 μm or less in terms of a roughness in a center line average height. This is because of the reason that if the average roughness in the central line exceeds 0.50 μm, a dielectric breakdown voltage of the film 20 for a film capacitor is likely to be reduced.

The metal roll 32 is used at a temperature of 300° C. or lower, preferably 270° C. or lower and more preferably 210° C. or lower. This is because of the reason that if a temperature of the metal roll 32 exceeds 300° C., the film 20 for a film capacitor is fused on the metal roll 32 and broken.

A thickness of the film 20 for a film capacitor is 0.5 to 10 μm, preferably 1.0 to 7.0 μm and more preferably 1.5 to 5.0 μm. This is because if a thickness of the film 20 for a film capacitor is less than 0.5 μm, a tensile strength of the film 20 for a film capacitor is notably reduced, so that production thereof becomes difficult. On the other hand, if a thickness of the film 20 for a film capacitor exceeds 10 μm, an electrostatic capacity thereof per volume is reduced.

A dielectric breakdown voltage of the film 20 for a film capacitor is 100 V/μm or more, preferably 200 V/μm or more and more preferably 250 V/μm or more at normal temperature. Further, it is 100 V/μm or more, preferably 180 V/μm or more and more preferably 200 V/μm or more at 150° C.

A dielectric breakdown voltage (absolute value) of the film 20 for a film capacitor is 500 V or more, more preferably 750 V more and further preferably 1000 V or more at normal temperature. It is suitably 500 V or more, preferably 650 V more and more preferably 800 V or more at 150° C. If a dielectric breakdown voltage of the film 20 for a film capacitor deviates from the above ranges, problems are brought about during using it as a film capacitor, and therefore attentions have to be paid.

According to the method described above, the molding material 1 obtained by adding the fluorocarbon resin to the PEI resin has a uniaxial elongational viscosity of 6,000 to 20,000 Pa·s, and therefore draw resonance can be prevented from being brought about to make it possible to manufacture stably the film 20 for a film capacitor at a high quality in a thin film having a thickness of 10 μm or less without causing unevenness. Further, the PEI resin having a glass transition point of 200° C. or higher and a dielectric breakdown voltage of 100 V/μm or more and the fluorocarbon resin having a continuous use temperature of 200° C. herefore the excellent voltage resistant characteristic can be obtained at high temperature.

Also, a process for manufacturing the film 20 for a film capacitor can be simplified more than ever, and the film does not have to be dried over a long period of time, so that the cost can be cut. Further, since a slit can be formed on the film 20 for a film capacitor which is continuous in a band form by the slit knife edge 50, the film 20 for a film capacitor can be arranged to a prescribed size by the slit, and simplification of the manufacturing process can be expected to a large extent.

Meanwhile, the fluorocarbon resin may be dispersed in a prescribed amount or more of the PEI resin in the molding material 1 to prepare a master batch. Also, the PEI resin in the molding material 1 may be used alone in a single kind, an alloy of two or more kinds thereof or a blend. Further, when the PFA resin or the FEP resin is selected as the fluorocarbon resin in the molding material 1, a strain curing area of the molding material 1 may be controlled in a range of an elongation rate of 10 s⁻¹ to 50 s⁻¹ in an elongational viscosity curve at a temperature of 340° C. to effectively inhibit draw down and draw resonance from being generated.

### EXAMPLES

The examples of the method for manufacturing the film for a film capacitor according to the present invention shall be explained together with comparative examples.

### Example 1

First, a PEI resin (trade name: Ultem 1010-1000, manufactured by SABIC Innovative Plastics Japan Ltd.) and a PFA resin (trade name: Freon PFA P-62PX, manufactured by Asahi Glass Co., Ltd.) of prescribed amounts shown in Table 1 were stirred and mixed for 30 minutes by means of a tumbler mixer. A melt viscosity of Freon PFA P-62PX was 11,100 poise.

After the PEI resin and the PFA resin were stirred and mixed in the manner described above to prepare a stirred mixture, this stirred mixture was supplied to a high speed double shaft melt extruding equipment (PCM30 L/D=35, manufactured by IKEGAI Corporation) equipped with a vacuum pump to melt and knead it under reduced pressure, and the kneaded matter was extruded in a bar form from a dice at a tip part of the high speed double shaft melt extruding equipment and cut after cooled with water to prepare a pellet-shaped molding material having a length of 4 to 6 mm and a diameter of 2 to 4 mm. The stirred mixture was molten and kneaded on the conditions of a cylinder temperature of 320 to 350° C., an adapter temperature of 360° C. and a dice temperature of 360° C. A uniaxial elongational viscosity of the molding material at 340° C. was measured after prepared.

Next, the molding material was left standing still for 24 hours in a hot air oven equipped with an exhaust port which was heated at 160° C. to dry it, and the above molding material was set in a single shaft melt extruding equipment of φ 40 mm (manufactured by IKG Corporation) equipped with a T dice having a width of 400 mm to melt and knead it. The molten and kneaded molding material was extruded continuously from the T dice of the single shaft melt extruding equipment to mold a thin film for a film capacitor in a band form.

When setting the molding material in the single shaft melt extruding equipment, nitrogen gas was supplied at 520 L/minute to the single shaft melt extruding equipment. A moisture content of the molding material in drying was 235 ppm. Further, the single shaft melt extruding equipment was set to L/D=25, a compression ratio of 2.5 and a screw of a full flight screw. A temperature of the single shaft melt extruding equipment was controlled to 320 to 340° C.; a temperature of the T dice was controlled to 340° C.; and a temperature of a connecting tube for connecting the single shaft melt extruding equipment and the T dice was controlled to 340° C. A resin temperature in an inlet of the T dice was measured for a temperature of the molding material to find that it was 340° C.

Then, both side parts of the molded film for a film capacitor were cut by means of a slit knife edge, and the film was wound up in order on a winding tube of a winding equipment to thereby manufacture the film for a film capacitor having a length of 1000 m, a width of 250 mm and a thickness of 5.3 μm. The film for a film capacitor was delivered in order to a pair of silicone rubber-made pressing rolls in a receiving equipment, a metal roll of 210° C. and a winding tube of 3 inch positioned in a downstream thereof, and it was interposed between the pressing roll and the metal roll.

A slit knife edge for cutting the film for a film capacitor was arranged up-and-down movably between the pressing roll and the winding tube, and a tension roll which was brought into contact with the film for a film capacitor by pressing to exert a tension thereon was disposed rotatably between the winding tube and the slit knife edge. After manufacturing the film for a film capacitor, a surface state of the film for a film capacitor was evaluated, and a dielectric breakdown voltage thereof was measured to summarize them in Table 1.

### Melt Viscosity:

The melt viscosity was measured by means of a flow tester (Shimadzu Flow Tester CFT-500 type A, manufactured by Shimadzu Corporation). The melt viscosity was measured by filling 1.5 cm³ of the resin in a cylinder (cylinder temperature: 360° C.) equipped with a dice (diameter: 1 mm, length: 10 mm), mounting a plunger (area: 1 cm²) on an upper part thereof, pre-heating it for 5 minutes when a temperature of the cylinder reached 360° C. and then applying immediately a load of 5 kgf to melt the fluorocarbon resin and allow it to flow.

### Thickness of Film:

A thickness of the film for a film capacitor was determined by an average thickness obtained by measuring thicknesses of 5 points in a width direction of the film for a film capacitor by means of a thickness meter of a contact type (trade name: Electron Micrometer Miloton 1240, manufactured by Mahr GmbH).

### Moldability of Film:

The moldability was evaluated by marking ◯ when the film for a film capacitor of a thin film having a thickness of 10 μm or less could be manufactured in a length of 1000 m and marking N.G. when it could not be manufactured.

### Surface State of Film:

A surface state of the film for a film capacitor was evaluated by feeling of touching with a hand, wherein ◯ was marked when a surface of the film for a film capacitor was smooth and provided no roughened feeling, and N.G. was marked when a surface of the film for a film capacitor was roughened.

### Uniaxial Elongational Viscosity:

A uniaxial elongational viscosity of the molding material was measured by means of a ROSAND twin capillary rheometer RH2200. To be specific, in a capillary die: φ 1.0 mm×effective length: 16 mm×180 degree, an orifice die: φ 1.0 mm×effective length: 0.25 mm×180 degree and temperature: 340° C., a range of a shear rate: 50 to 5000 s⁻¹ was measured to determine the uniaxial elongational viscosity in a range of an elongational rate: 10 to 50 s⁻¹.

### Dielectric Breakdown Voltage of Film:

A dielectric breakdown voltage of the film for a film capacitor was measured by a short time dielectric breakdown method carried out by an aerial method according to a JIS C 2110-1994 method, and the dielectric breakdown voltage was shown by a dielectric breakdown voltage value per a unit thickness by dividing the above measured value by a thickness of the measured sample. The above measurement was carried out under environment of 23° C. and 150° C., and the measurement was carried out from a winding outside of the film for a film capacitor. A type of a cylindrical form (upper part form: diameter: 25 mm, height: 25 mm; lower part form: diameter: 25 mm, height: 15 mm) was used for the electrode.

### Example 2

First, the PEI resin (trade name: Ultem 1010-1000, manufactured by SABIC Innovative Plastics Japan Ltd.) and a PFA resin (trade name: Freon PFA P-65P, manufactured by Asahi Glass Co., Ltd.) of prescribed amounts shown in Table 1 were stirred and mixed for 30 minutes by means of a tumbler mixer. A melt viscosity of Freon PFA P-65P was 102,000 poise. After the PEI resin and the PFA resin were stirred and mixed in the manner described above to prepare a stirred mixture, this stirred mixture was used to prepare a molding material by the same method as in Example 1, and a uniaxial elongational viscosity of the above molding material was measured. The uniaxial elongational viscosity fell in a range of 9,000 to 15,000 Pa·s.

Next, the molding material was left standing still for 24 hours in a hot air oven equipped with an exhaust port which was heated at 160° C. to dry it, and a film for a film capacitor was molded in a band form by the same method as in Example 1. When setting the molding material in the single shaft melt extruding equipment, nitrogen gas was supplied at 520 L/minute to the single shaft melt extruding equipment. A moisture content of the molding material in drying was 309 ppm. Further, a temperature of the single shaft melt extruding equipment was controlled to 320 to 340° C.; a temperature of the T dice was controlled to 340° C.; and a temperature of a connecting tube for connecting the single shaft melt extruding equipment and the T dice was controlled to 340° C. A resin temperature in an inlet of the T dice was measured for a temperature of the molding material to find that it was 340° C.

After the film for a film capacitor was molded in a band form, both side parts of the molded film for a film capacitor were cut, as was the case with Example 1, by means of a slit knife edge, and the film was wound up in order on the winding tube to thereby manufacture the film for a film capacitor having a length of 1000 m, a width of 250 mm and a thickness of 5.2 μm. A surface state of the film was evaluated by the same method as in Example 1, and a dielectric breakdown voltage thereof was measured to summarize them in Table 1. The uniaxial elongational viscosity fell in a range of 9,000 to 15,000 Pa·s.

### Example 3

A PEI resin (trade name: Ultem CRS5001-1000, manufactured by SABIC Innovative Plastics Japan Ltd.) and an FEP resin (trade name: Neofron FEP NP-21, manufactured by Daikin Industries, Ltd.) of prescribed amounts shown in Table 1 were stirred and mixed for 30 minutes by means of a tumbler mixer. A melt viscosity of Neofron FEP NP-21 was 46,000 poise. After the PEI resin and the FEP resin were stirred and mixed to prepare a stirred mixture, this stirred mixture was used to prepare a molding material by the same method as in Example 1, and a uniaxial elongational viscosity thereof was measured.

Next, the molding material was left standing still for 24 hours in a hot air oven equipped with an exhaust port which was heated at 160° C. to dry it, and a thin film for a film capacitor was molded in a band form by the same method as in Example 1. When setting the molding material, nitrogen gas was supplied at 520 L/minute. A moisture content of the molding material in drying was 271 ppm. Further, a temperature of the single shaft melt extruding equipment was controlled to 320 to 340° C.; a temperature of the T dice was controlled to 340° C.; and a temperature of a connecting tube for connecting the single shaft melt extruding equipment and the T dice was controlled to 340° C. A resin temperature in an inlet of the T dice was measured for a temperature of the molding material to find that it was 340° C.

After the film for a film capacitor was molded in a band form, both side parts of the molded film for a film capacitor were cut, as was the case with Example 1, by means of a slit knife edge, and the film was wound up in order on the winding tube to thereby manufacture the film for a film capacitor having a length of 1000 m, a width of 250 mm and a thickness of 3.6 μm. A surface state of the film for a film capacitor was evaluated by the same method as in Example 1, and a dielectric breakdown voltage thereof was measured to summarize them in Table 1. The uniaxial elongational viscosity fell in a range of 10,000 to 18,000 Pa·s.

### Example 4

The PEI resin (trade name: Ultem CRS5001-1000, manufactured by SABIC Innovative Plastics Japan Ltd.) and an FEP resin (trade name: Neofron FEP NP-102, manufactured by Daikin Industries, Ltd.) of prescribed amounts shown in Table 1 were stirred and mixed for 30 minutes by means of a tumbler mixer. A melt viscosity of Neofron FEP NP-102 was 11,700 poise.

After the PEI resin and the FEP resin were stirred and mixed to prepare a stirred mixture, this stirred mixture was used to prepare a molding material by the same method as in Example 1, and a uniaxial elongational viscosity of the above molding material was measured.

Next, the molding material was left standing still for 24 hours in a hot air oven equipped with an exhaust port which was heated at 160° C. to dry it, and a thin film for a film capacitor was molded in a band form by the same method as in Example 1. Also in this case, nitrogen gas was supplied at 520 L/minute. A moisture content of the molding material in drying was 264 ppm. Further, a temperature of the single shaft melt extruding equipment was controlled to 320 to 340° C.; a temperature of the T dice was controlled to 340° C.; and a temperature of a connecting tube for connecting the single shaft melt extruding equipment and the T dice was controlled to 340° C. A resin temperature in an inlet of the T dice was measured for a temperature of the molding material to find that it was 340° C.

After the film for a film capacitor was molded in a band form, both side parts of the molded film for a film capacitor were cut, as was the case with Example 1, by means of a slit knife edge, and the film was wound up in order on the winding tube to thereby manufacture the film for a film capacitor having a length of 1000 m, a width of 250 mm and a thickness of 6.5 μm. A surface state of the film for a film capacitor was evaluated by the same method as in Example 1, and a dielectric breakdown voltage thereof was measured to summarize them in Table 1. The uniaxial elongational viscosity fell in a range of 10,000 to 18,000 Pa·s.

### Comparative Example 1

First, the PEI resin (trade name: Ultem 1010-1000, manufactured by SABIC Innovative Plastics Japan Ltd.) and a PFA resin (trade name: Freon PFA P-62XP, manufactured by Asahi Glass Co., Ltd.) of prescribed amounts shown in Table 2 were stirred and mixed for 30 minutes by means of a tumbler mixer to prepare a stirred mixture, and this stirred mixture was used to prepare a molding material by the same method as in Example 1. A uniaxial elongational viscosity of the above molding material was measured.

Next, the molding material was left standing still for 24 hours in a hot air oven equipped with an exhaust port which was heated at 160° C. to dry it, and a thin film for a film capacitor was molded in a band form by the same method as in Example 1. When setting the molding material in the single shaft melt extruding equipment, nitrogen gas was supplied at 520 L/minute to the single shaft melt extruding equipment. A moisture content of the molding material in drying was 316 ppm. Further, a temperature of the single shaft melt extruding equipment was controlled to 320 to 340° C.; a temperature of the T dice was controlled to 340° C.; and a temperature of a connecting tube for connecting the single shaft melt extruding equipment and the T dice was controlled to 340° C. A resin temperature in an inlet of the T dice was measured for a temperature of the molding material to find that it was 340° C.

After the film for a film capacitor was molded, the same procedure as in Example 1 was tried to be carried out, but draw resonance was heavily generated during molding the film for a film capacitor, and an end part of the film for a film capacitor undulated, so that the film was broken from an end part thereof at a point of time when the film was manufactured up to a length of 419 m. The film for a film capacitor having a length of 419 m, a width of 250 mm and a thickness of 5.3 μm was obliged to be stopped being manufactured. Then, a surface state of the film for a film capacitor was evaluated by the same method as in Example 1, and a dielectric breakdown voltage thereof was measured to summarize them in Table 2. The other items were measured by the same methods as in Example 1. The uniaxial elongational viscosity was 3,000 or more and less than 6,000 Pa·s.

### Comparative Example 2

The PEI resin (trade name: Ultem CRS5001-1000, manufactured by SABIC Innovative Plastics Japan Ltd.) and the FEP resin (trade name: Neofron FEP NP-21, manufactured by Daikin Industries, Ltd.) of prescribed amounts shown in Table 2 were stirred and mixed for 30 minutes by means of a tumbler mixer to prepare a stirred mixture, and this stirred mixture was used to prepare a molding material by the same method as in Example 1. A uniaxial elongational viscosity thereof was measured.

Next, the molding material was left standing still for 24 hours in a hot air oven equipped with an exhaust port which was heated at 160° C. to dry it, and a thin film for a film capacitor was tried to be molded in a band form by the same method as in Example 1. A moisture content of the molding material in drying was 230 ppm. Further, a nitrogen gas was supplied as was the case with Example 1.

The film for a film capacitor having a thickness of 10 μm or less was tried to be molded, but melt stretching of a molten kneaded matter extruded from the dice 12 was very small, and the molten kneaded matter was broken between the dice and the metal roll, so that the film for a film capacitor having a thickness of 10 μm or less could not be molded. Accordingly, it was given up to measure a dielectric breakdown voltage of the film for a film capacitor.

### Comparative Example 3

The PEI resin (trade name: Ultem 1010-1000, manufactured by SABIC Innovative Plastics Japan Ltd.) and a PFA resin (trade name: Freon PFA P-66PT, manufactured by Asahi Glass Co., Ltd.) of prescribed amounts shown in Table 2 were stirred and mixed for 30 minutes by means of a tumbler mixer. A melt viscosity of Freon PFA P-66PT was 150,000 poise. The PEI resin and the PFA resin were stirred and mixed in the manner described above to prepare a stirred mixture, and then this stirred mixture was used to prepare a molding material by the same method as in Example 1. A uniaxial elongational viscosity thereof was measured.

Next, the molding material was left standing still for 24 hours in a hot air oven equipped with an exhaust port which was heated at 160° C. to dry it, and a thin film for a film capacitor was molded in a band form by the same method as in Example 1. A moisture content of the molding material in drying was 295 ppm. Further, a nitrogen gas was supplied as was the case with Example 1.

After the film for a film capacitor was molded, both side parts of the above continuous film for a film capacitor were cut by means of a slit knife edge, and the film was wound up in order on the winding tube to thereby manufacture the film for a film capacitor having a length of 1000 m, a width of 250 mm and a thickness of 6.1 μm. After the film for a film capacitor was manufactured in the manner described above, a surface state of the film for a film capacitor was evaluated by the same method as in Example 1, and a dielectric breakdown voltage thereof was measured to summarize them in Table 2. A surface of the film for a film capacitor was touched by a hand to find that the surface was roughened.

TABLE 1

| | | | Example | | | |
|---|---|---|---|---|---|---|
| | | | 1 | 2 | 3 | 4 |
| Composition | PEI | Trade name | Ultem | Ultem | CRS5001 | CRS5001 |
| | resin | | 1010-1000 | 1010-1000 | | |
| | | Addition amount | 100 | 100 | 100 | 100 |
| | | (mass part) | | | | |
| | Fluoro- | Kind | PFA resin | PFA resin | FEP resin | FEP resin |
| | carbon | Trade name | P-62XP | P-65P | N-21 | N-102 |
| | resin | Melt viscosity (poise) | 11,100 | 102,000 | 46,000 | 11,700 |
| | | Addition amount | 5 | 3 | 10 | 25 |
| | | (mass part) | | | | |

| Uniaxial elongational viscosity (Pa · s) | | 9000 to | 9000 to | 10,000 to | 10,000 to |
|---|---|---|---|---|---|
| | | 15,000 | 15,000 | 18,000 | 18,000 |
| Moldability of film | | ◯ | ◯ | ◯ | ◯ |
| Surface state of film | | ◯ | ◯ | ◯ | ◯ |
| Dielectric | 23° C. | 308 | 335 | 340 | 323 |
| breakdown | 150° C. | 267 | 269 | 300 | 285 |
| voltage (V/μm) | | | | | |

TABLE 2

| | | | Comparative Example | | |
|---|---|---|---|---|---|
| | | | 1 | 2 | 3 |
| Compo- | PEI | Trade name | Ultem 1010-1000 | CRS5001 | Ultem 1010-1000 |
| sition | resin | Addition amount | 100 | 100 | 100 |
| | | (mass part) | | | |
| | Fluoro- | Kind | PFA resin | FEP resin | PFA resin |
| | carbon | Trade name | P-62XP | NP-21 | P-66PT |
| | resin | Melt viscosity (poise) | 11,100 | 46,000 | 150,000 |
| | | Addition amount | 0.3 | 35 | 5 |
| | | (mass part) | | | |

| Uniaxial elongational viscosity (Pa · s) | | 3000 to 6000 | 23.000 to 30,000 | 7,000 to 19,000 |
|---|---|---|---|---|
| Moldability of film | | N.G. | N.G. | ◯ |
| Surface state of film | | ◯ | The film could | N.G. |
| Dielectric | 23° C. | 336 | not be molded, | 83 |
| breakdown | 150° C. | 319 | and therefore | 69 |
| voltage (V/μm) | | | it was not | |
| | | | evaluated | |

In Table 1 and Table 2, 1010 shows the PEI resin (trade name: Ultem 1010-1000, manufactured by SABIC Innovative Plastics Japan Ltd.), and CRS5001 shows the PEI resin (trade name: Ultem CRS5001-1000, manufactured by SABIC Innovative Plastics Japan Ltd.). Further, P-62PX is the PFA resin (trade name: Freon PFA P-62PX, manufactured by Asahi Glass Co., Ltd.); P-65P is the PFA resin (trade name: Freon PFA P-65P, manufactured by Asahi Glass Co., Ltd.); NP-21 is the FEP resin (trade name: Neofron FEP NP-21, manufactured by Asahi Glass Co., Ltd.); and NP-102 is the FEP resin (trade name: Neofron FEP NP-102, manufactured by Asahi Glass Co., Ltd.).

### Results:

All of the films for a film capacitor prepared in the examples and Comparative Example 1 had a dielectric breakdown voltage of 250 V/μm or more, but in a case of Comparative Example 1, the film for a film capacitor having a thickness of 10 μm or less could not be stably manufactured.

In a case of Comparative Example 2, the film for a film capacitor of a thin film having a thickness of 10 μm or less could not be manufactured. Further, the film for a film capacitor prepared in Comparative Example 3 was touched by a hand to find that a surface thereof was roughened, and in addition thereto, a dielectric breakdown voltage thereof was confirmed to be reduced to a large extent.

As apparent from the above, the films for a film capacitor prepared in the examples can be manufactured in a thickness of 10 μm or less, and they have an excellent dielectric breakdown voltage and are most suitable for a film capacitor.

What is claimed is:

1. A method for manufacturing a film for a film capacitor comprising the steps of feeding a molding material into an extruding equipment, extruding a film for a film capacitor downward from a dice, interposing the above extruded film for a film capacitor between a pressing roll and a cooling roll to cool it and winding up the cooled film for a film capacitor having a thickness of 10 μm or less on a winding device, wherein the molding material is prepared by adding a fluorocarbon resin to a polyetherimide resin having a glass transition point of 200° C. or higher and a dielectric breakdown voltage of 100 V/μm or more; and a uniaxial elongational viscosity of the molding material is controlled to a range of 6,000 to 20,000 Pa·s.

2. A film capacitor manufactured by the method for manufacturing a film for a film capacitor as described in claim 1.
